(19) United States
(12) Patent Application Publication
(10) Pub. No.: US 2002/0187000 A1
(43) Pub. Date: Dec. 12, 2002

(54) Method for producing a mechanical link

(76) Inventors: Christoph Heier, Iffezheim (DE); Juergen Bassler, Winnenden (DE); Stefan Boell, Illmensee (DE)

Correspondence Address: Striker Striker & Stenby, 103 East Neck Road, Huntington, NY, 11743, US

(21) Appl. No.: 10/069,854

(22) PCT Filed: Jul. 3, 2001
(86) PCT No.: PCT/DE01/02397

(30) Foreign Application Priority Data
Jul. 4, 2000 (DE) 100 32 331.6

(51) Int. Cl. B25G 3/28

(52) U.S. Cl. 403/282

(57) ABSTRACT

Methods for producing a mechanical connection according to the related art allow only minimal tolerances or are costly to produce.

These disadvantages are eliminated by means of a method according to the invention for producing a mechanical connection comprising ends (10, 11) that are designed similar to a dovetail connection and are connected to each other.

### RELATED ART

The invention is based on a method for producing a mechanical connection according to the definition of the species in claim 1.

“Flared-fitting joints” are known, in which two workpieces are inserted into each other in such a fashion that the one workpiece bears against a stop of the other and extends over this with one edge, the flange end. The joining is carried out by beading—flanging—the flange end onto the one workpiece, so that the workpieces are joined with positive engagement. Two workpieces are required for this type of connection, and obtaining a defined contour of the beaded flange end is costly. Often, a flange end must extend around the entire circumference of a workpiece.

Furthermore, “dovetail connections” are known, in which tolerances must be adhered to within very narrow limits. In the joining process, a head piece and a recess of the dovetail connection are placed on top of one another and then pressed into each other, as described in DE 39 25 365 A1. The parts must thereby be placed on top of each another, and they are not pushed into each other. As such, the parts to be joined must be designed somewhat longer, and the tolerance, e.g., of an internal diameter of a tube element, is greater.

A joining of structural parts by means of elastic retaining arms is made known in DE 38 15 927 A1. With this embodiment, however, gaps unavoidably occur between the structural parts. A gapless transition between the structural parts is not possible.

A joining method for a metal band is made known in U.S. Pat. Ser. No. 2,283,918, with which a tongue is caulked into a recess. A bulky tool and strong forces are required to perform the caulking.

A detent connection comprising a tab and a recess is made known in U.S. Pat. Ser. No. 3,502,922. The tab and the recess are pushed together to produce a connection. The areas around the recess are designed to be elastic so they can expand and spring back when the tab and recess are pushed together.

### Advantages of the Invention

In contrast, the method according to the invention for producing a mechanical connection having the characteristic features of claim 1 has the advantage that at least two sections of a workpiece can be connected to each other in simple fashion, and tolerances of at least one workpiece do not have to be adhered to within very narrow limits.

Advantageous further developments and improvements of the method for producing a mechanical connection according to the invention, and the connection produced in this fashion, are possible by means of the process steps or measures listed in the dependent claims.

It is furthermore advantageous that the joining element has a locating element, because this simplifies assembly and/or centering.

An advantageous embodiment of the joining element occurs by the fact that there is no radial or axial overhang on the workpiece.

The joining element can be used in advantageous fashion for a tube element when the tube element is secured on an internal member by means of the action of the joining element, and this internal member has two short guide lengths.

### BRIEF DESCRIPTION OF THE DRAWINGS

Exemplary embodiments of the invention are shown in simplified form in the drawing and are explained in greater detail in the subsequent description.

FIGS. 1a, 1b show a joining element in the open and connected state, respectively,

FIGS. 2a, b show a joining element and an internal member with short guide lengths, and

FIG. 3 shows a possible installed state of the joining element.

### DETAILED DESCRIPTION OF THE EXEMPLARY EMBODIMENTS

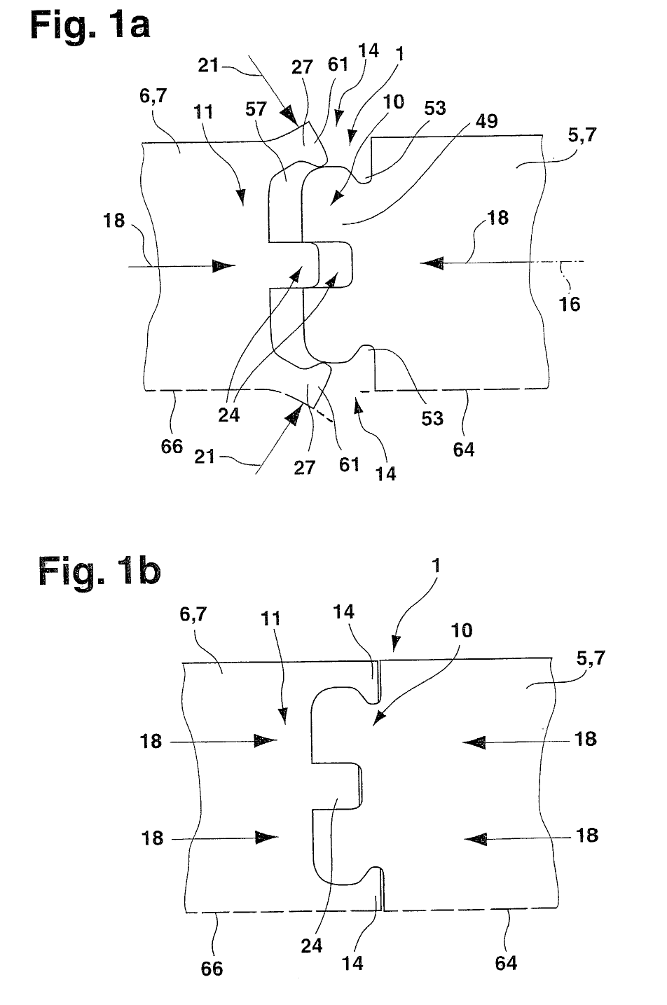

FIG. 1a shows a joining element 1 that can connect a first workpiece 5 and, e.g., a second workpiece 6 with each other. The two workpieces 5, 6 can also be sections of a workpiece 7, e.g., a tube element 7 bent out of a rectangular sheet-metal strip.

One end 10 of the first workpiece 5 and one end 11 of the second workpiece 6 correspond to a modified dovetail shape 14 and form the joining element 1.

The arrows 18 show, for example, the direction in which the ends 10, 11 are inserted into each other. The ends 10, 11 are pushed together, for example, until the ends 10, 11 touch and bear against each other. This is not absolutely necessary, however.

The at least one workpiece 5, 6, 7, for instance, further comprises at least one locating element 24 that is developed on the ends 10, 11 and/or simplifies assembly. The workpieces 5, 6, 7 have a longitudinal or center line 16 that extends through the center of the locating element 24, for instance.

In this exemplary embodiment, the end 11 comprises a projection to form the locating element 24, and the end 10 comprises a corresponding recess into which the projection is inserted with the least amount of play possible when centering is required, for example.

The workpiece 5, 7 and the workpiece 6, 7 each have outer boundary lines 64, 66—shown here as dashed lines—and that extend, continued in linear fashion, past the ends 10, 11. The lines 64, 66 extend not nearly parallel to each other when the mechanical connection has not yet been produced.

If the ends 10, 11 or two workpieces 5, 6 are inserted into each other, at least one existing edge 27 of a workpiece 6 that rises above the other workpiece 5 is bent by means of a force F acting in a certain direction indicated using the arrows 21.

The profile 14 designed in the shape of a dovetail is formed on the end 10, for example, by means of a head piece 49 abutted by a constricted neck section 53. The end 11 is provided with a cavity 57 matched to this, which cavity 57 is bordered on both sides, for example, by an edge 27. The exposed ends of the edges 27, which are pulled slightly outward away from the cavity 57, point toward each other. Noses 61 are provided, between which the head piece 49 can be pushed into the cavity 57. The noses 61 are designed so that, once the force F has been applied, they grip in the neck section 53 in mated fashion. The locating element 24 is provided in the head piece 49 or in the cavity 57.

The workpieces 5, 6 connected to each other according to the method according to the invention are shown in FIG. 1b. In this exemplary embodiment, the ends 10, 11 bear against each other. The joining element 1 is designed in such a fashion, for example, that there is no radial and/or axial overhang, and the workpieces 5, 6 are connected to each other with positive engagement.

The boundary lines 64, 66 now extend nearly parallel to each other.

The profile 14 designed in the shape of a dovetail is thereby shaped in such a fashion, for example, that, when the edge 27 is bent, tensile stress is placed on both workpieces 5, 6 in the circumferential direction.

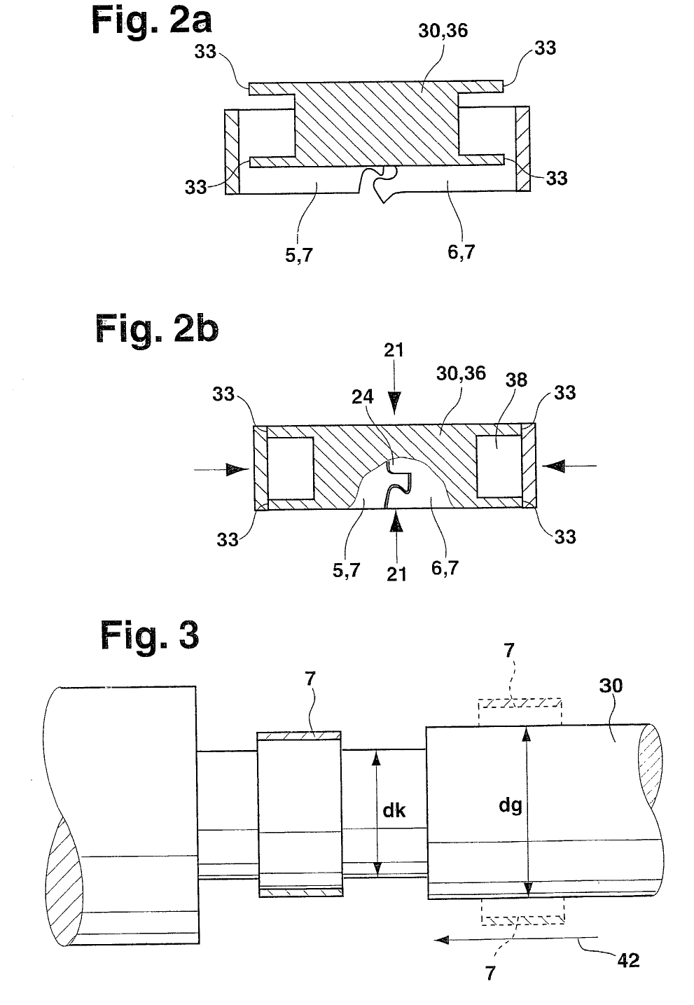

FIG. 2a shows the tube element 7 in the opened state. In this state, it has a greater internal diameter than the greatest outer diameter of an internal member 30, so that the tube element 7 can be pushed over the internal member 30.

When installing the tube element 7 on the internal member 30, the tube element 7 is guided, for example, by two guide lengths 33 of the internal member 30 overhanging in the radial direction. If the joining element 1 is closed, the tube element 7 bears tightly against the guide lengths 33 and is secured to the internal member 30 by means of this (FIG. 2b).

FIG. 2b shows how the tube element 7 is secured to the internal member 30. The internal member 30 has two short guide lengths 33, for example. “Short” in this case means that a contact length in the axial direction of the tube element 7 with the internal member 30 is markedly shorter than an axial length of the internal member 30. The contact length can also correspond to the entire axial length of the internal member 30.

The internal member 30 is, e.g., a coil form for a stator, for example, of an electric motor that has a coil space 38 in which a coil (not shown) is wound, for example. The tube element 7 thereby forms a magnetic return element, for example. With a positive connection, the magnetic lines of flux in the return element can extend from the end 10 to the end 11 without great magnetic resistance.

FIG. 3 shows how, e.g., a tube element 7 in the open state can be pushed over an internal member 30—that has areas with two different outer diameters, dg and dk—in a direction of insertion indicated by an arrow 42. The diameter dg is greater than the diameter dk, and the area having the outer diameter dk is enclosed by areas that have a greater outer diameter. The tube element 7 can therefore be secured on the internal member 30 in the region of the smaller outer diameter dk without the ends of the tube element 7 having to be expanded so far that the distance between the ends (10, 11) correspond to that of the outer diameter dk.

What is claimed is:

1. A method for producing a mechanical connection of at least one workpiece (5, 6, 7), in particular at least one component of an electric motor, with a joining element (1) that comprises two ends (10, 11) that are designed to be capable of being at least partially inserted into each other and similar to a dovetail shape (14), and one end (10) extends over the other end (11) at least partially with at least one edge (27), wherein the ends (10, 11) are first pushed together until, at the most, they bear against each other, whereby the edge (27), at the most, is bent partially upward in elastic fashion, and the at least one edge (27) of one end (11) is bent toward the other end (10) by means of an action of force (21).

2. The method according to claim 1, wherein

3. The ends (10, 11) are connected to each other via a positive connection.

4. A joining element according to claim 1, wherein the joining element (1) has at least one locating element (24).

5. The joining element according to claim 1 or 3, wherein the joining element (1), in the connected state, does not overhang in the radial direction.

6. The joining element according to one or more of the claims 1, 3, or 4, wherein the joining element (1), in the connected state, does not overhang in the axial direction.

7. The joining element according to claim 1, wherein the workpiece (5, 6) forms a tube element (7), the tube element (7) is secured to at least one internal member (30), and the internal member (30) has at least two guide lengths (33) that extend in the radial direction, the axial lengths of which are short compared to an axial length of the tube element (7).

8. The joining element according to claim 6, wherein the internal member (30) is a coil form (36) of an electric motor.

9. The joining element according to claim 1 or 6, wherein the workpiece (5, 6) forms a tube element, and the tube element (7) serves as return element.

10. The method according to claim 1, wherein the at least one workpiece (5, 6, 7) has two outer boundary lines (64, 66) continued in linear fashion over the ends (10, 11) that are not parallel to each other before the two sections are fit together, and the edge (27) is bent toward the centerline by means of an action of force until the outer boundary lines (64, 66) are approximately parallel to each other.
